(19) United States
(12) Patent Application Publication
(10) Pub. No.: US 2012/0006027 A1
(43) Pub. Date: Jan. 12, 2012

(54) RENEWABLE ENERGY EXTRACTION

(76) Inventors: Osman Kibar, San Diego, CA (US); Mirianas Chachisvilis, San Diego, CA (US)

(21) Appl. No.: 13/176,825

(22) Filed: Jul. 6, 2011

Related U.S. Application Data
(60) Provisional application No. 61/361,977, filed on Jul. 7, 2010.
(60) Provisional application No. 61/480,724, filed on Apr. 29, 2011.

(51) Int. Cl. F03G 7/00

(52) U.S. Cl. 60/721

(57) ABSTRACT

Among other things, renewable energy is extracted from an asymmetric system (or the ability of the system to have renewable energy extracted from it is enhanced, or both) that is characterized by one or more stochastic variables, which exhibit at least one statistical component that is not Gaussian and/or not white.

### BACKGROUND

This application is entitled to the benefit of the filing date of U.S. provisional application Ser. 61/361,977, filed on Jul. 7, 2010, and U.S. provisional application Ser. 61/480,724, filed on Apr. 29, 2011, both of which are incorporated here by reference in their entireties.

This description relates to renewable energy extraction.

### SUMMARY

In general, in an aspect, renewable energy is extracted from an asymmetric system (or the ability of the system to have renewable energy extracted from it is enhanced, or both) that is characterized by one or more stochastic variables, which exhibit at least one statistical component that is not Gaussian and/or not white.

Implementations may include one or more of the following features. The energy is extracted in the form of power. The energy comprises electrical, thermal, chemical, or radiative energy or a combination of them. At least part of the system is in a solid phase, a liquid phase, a gas phase or an intermediate phase or a combination of them. At least part of the system is in a solid phase comprising a semiconductor, an amorphous material, an organic material, or a plasma, or a combination of them. The energy is extracted from conduction electrons, valence holes, phonons and/or a subset or combination of such electrons, holes or phonons that are present in the system, or a combination of them. The asymmetric system comprises an asymmetry of a fixed structure in the system, of an intrinsic aspect of the system, of an externally fabricated feature of the system, or is imposed on the system by an externally applied force, or a combination of them. The asymmetric system comprises an asymmetry that is spatial or temporal or a combination of them, and is deterministic or stochastic or a combination of them. The stochastic variables comprise thermodynamic or other microscopic variables or a combination of them, such as temperature, entropy, enthalpy, or kinetic energy of charge carriers or a combination of them, such as translational, rotational, or vibrational energy or a combination of them. At least one of the stochastic variables is spatial or temporal or a combination of them. At least one of the stochastic variable is an amplitude or a temporal or spatial pattern or a combination of them. The statistical component has a mean value of zero, or non-zero. The statistical component is intrinsic to the system or designed into the structure of the system or externally applied to the system or a combination of them. The non-localization or correlation effects in the system or a combination of them are increased or optimized. The increase or optimization is spatial or temporal dimension or a combination of them. The method includes improved or optimized performance. The extraction of energy is improved or optimized in net output power, heat management, stability, reliability, manufacturability, or cost, or a combination of them. The improvement or optimization includes causing a frequency of events, a thermal diffusion coefficient, a non-thermal diffusion coefficient, a kick amplitude, a barrier height, a load voltage, or a load current, or a combination of them to fall within a particular range or particular ranges of values. The improvement or optimization includes applying one or more biases to one or more system parameters. The energy is extracted in the Ratchet regime or in the Delta regime or in a transition regime between the two, or in a combination of them. The energy is extracted using quantum effects, such as tunneling currents, non-localized electron wavefunctions, or interference effects or a combination of them. Heat energy flows in from the ambient environment to permit continuous extraction of energy. The energy is extracted in the presence of a load. The power is used externally to the asymmetric system.

In general, in an aspect, an asymmetric system from which renewable energy can be extracted comprises a fabricated structure that is characterized by an asymmetry, and causes at least one statistical component exhibited by one or more stochastic variables to be not Gaussian or not white or both, the energy extractable from the structure being greater than all control and ancillary elements required for the extraction consume.

Implementations may include one or more of the following features The fabricated structure comprises a semiconductor material, such as silicon, graphite or graphene or a combination of them. The asymmetry comprises a lateral or vertical structure comprising two or more layers of two or more different materials or of two or more different doping levels, or a combination of them in the structure. The stochastic variables comprise thermal fluctuations, for example, of conduction electrons or valence holes or a combination of them. The statistical component has a Poisson distribution.

In general, in an aspect, a fabricated structure from which renewable energy can be extracted comprises an asymmetry and is characterized by at least one statistical component exhibited by one or more stochastic variables that are not Gaussian not white or both.

Implementations may include one or more of the following features. The structure comprises a stack of wafers.

In general, in an aspect, a structure is fabricated from which renewable energy can be extracted, the fabricating comprising imparting to the structure an asymmetry and causing at least one statistical component exhibited by one or more stochastic variables associated with the structure to be not Gaussian and/or not white.

Implementations may include one or more of the following features. Heat is supplied from the ambient to permit continuous extraction of energy. The energy is extracted in the presence of a load.

Among the advantages of various aspects, features, and implementations that we describe here are one or more of the following.

Renewable electricity or other types of energy can be generated from ambient heat, using the thermal fluctuations present in all matter. The renewal energy generation can employ solid state materials, and does not require any permanent thermal or electro-chemical gradients. Distributed generation should be possible at a capital cost (˜$0.6-2/W) that is comparable to the capital cost of coal plants (˜$1.5-2/W), but with no fuel cost and little maintenance cost. A utilization factor of 24/7 should be possible, with no siting constraints (e.g., no need for direct sunlight or wind). The energy generation should be scalable from watts to megawatts without loss of efficiency, with a power density of ˜100's of Watts to kiloWatt's per liter and/or per kilogram, allowing applications in commercial and residential electricity generation markets, as well as portable, military, and transportation applications, to name a few.

These and other aspects, features, and implementations, and combinations of them may be expressed as methods, apparatus, systems, components, compositions of matter, means or steps for performing functions, business methods, program products, and in other ways.

Other aspects, features, and implementations will become apparent from the following description and from the claims.

### DESCRIPTION

FIG. 1 shows magnitude and rate of temperature fluctuations as function of system size in silicon.

FIG. 2 shows schematics of ratchet potential.

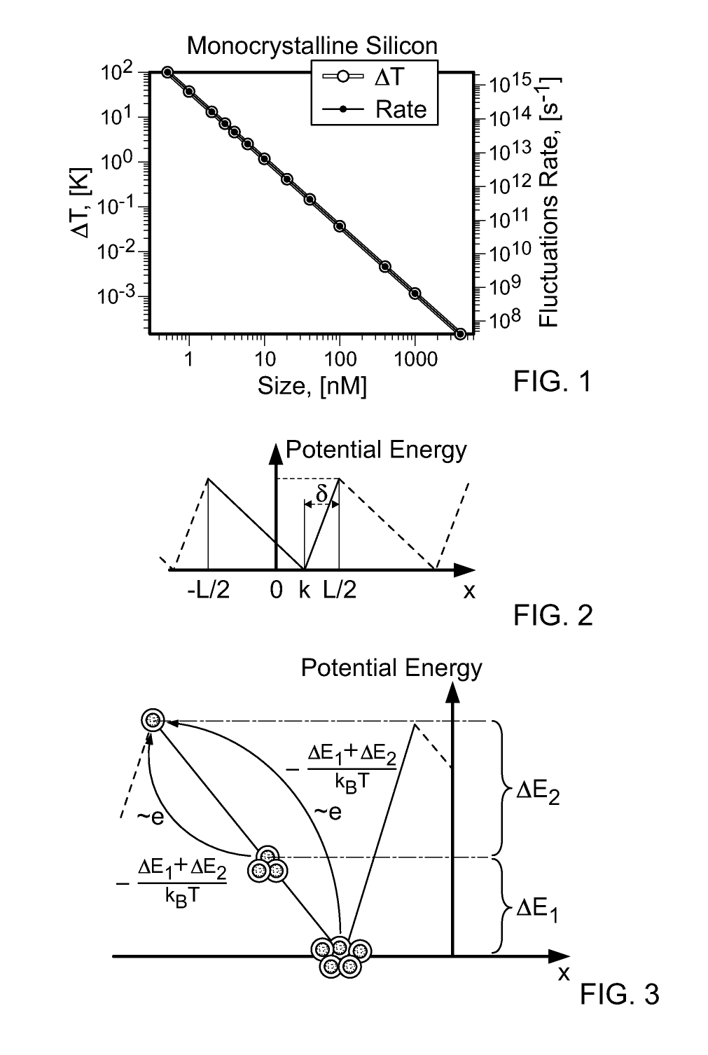

FIG. 3 shows how an exponential dependence of both transition rate over the barrier and population on energy leads to cancelation of particle current.

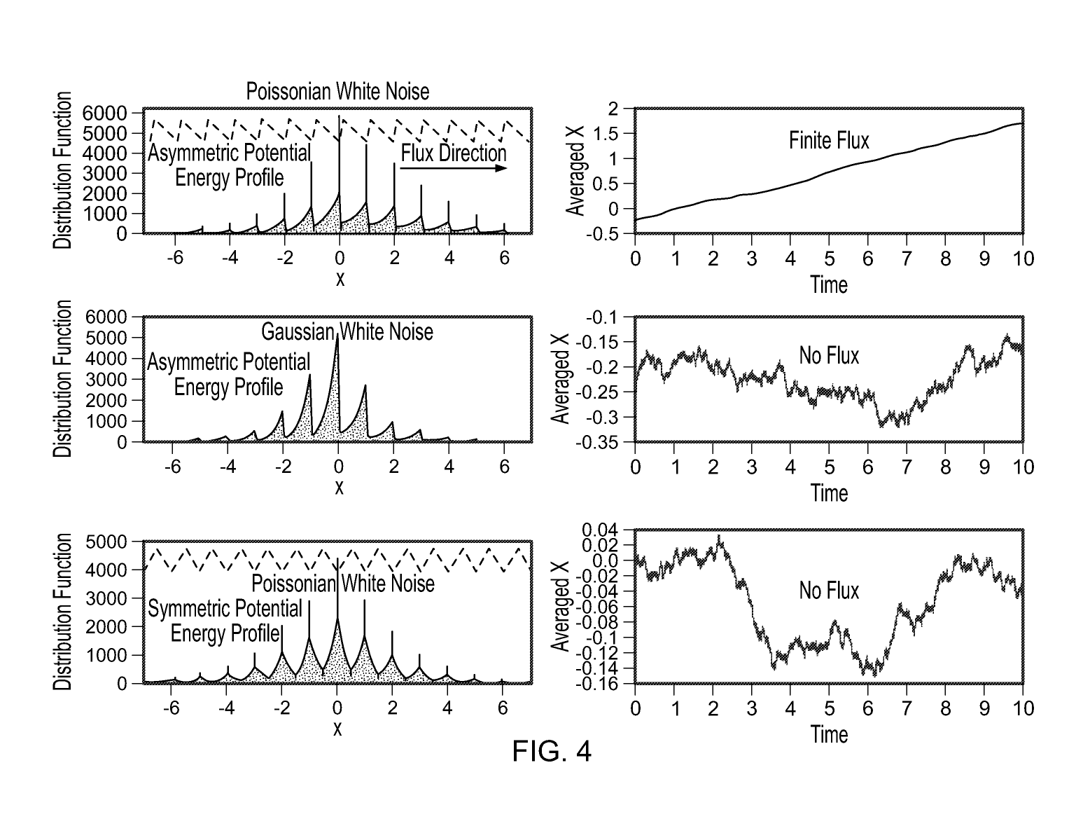

FIG. 4 shows the effect of asymmetry of the potential energy profile on particle population distribution functions (at t=10 sec) and average particle position as a function of time under the influence of Poissonian and Gaussian white noise. Initial particle position is at x=−0.248, corresponding to an expected average position at thermal equilibrium. Presented data are averaged over 2000 trajectories each containing 106 time steps.

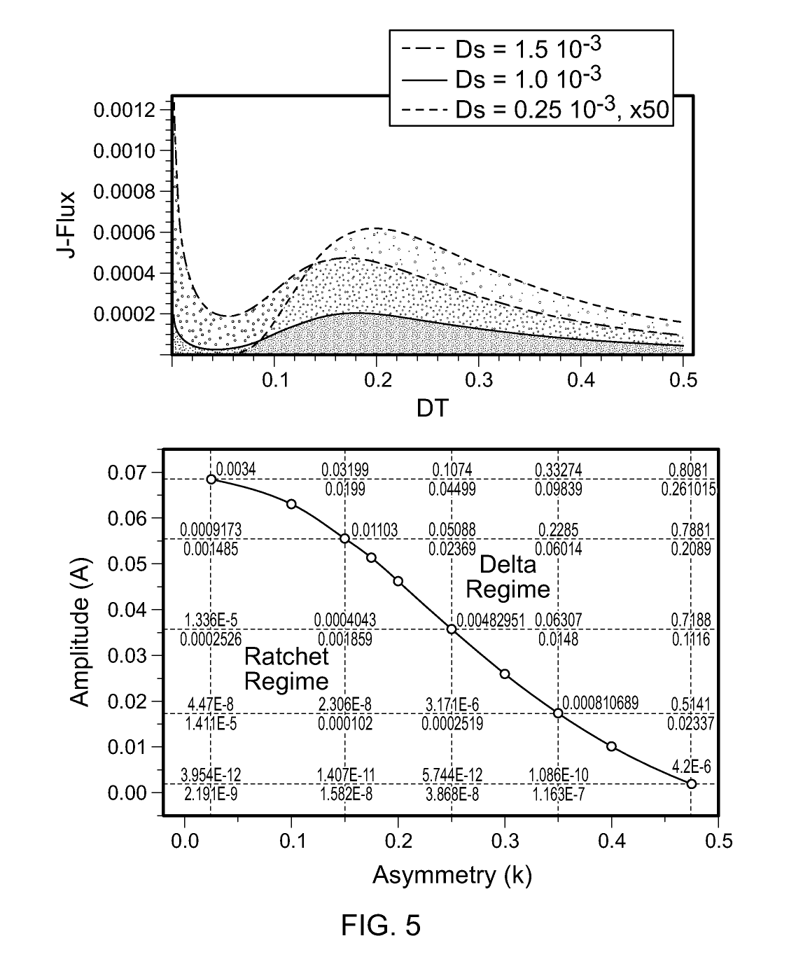

FIG. 5 shows (in the top panel) the dependence of flux on thermal diffusion coefficient (e.g., on temperature) for three different values of Ds·(Dₛ=λA²) and (in the bottom panel) a phase diagram separating a true ratchet regime from a delta regime. Numbers on the graph indicate flux values at D_{T}=0.001 (top number) and at D_{T}≈0.2 (bottom number). λ=10, k=0.475, L=1. All quantities are dimensionless.

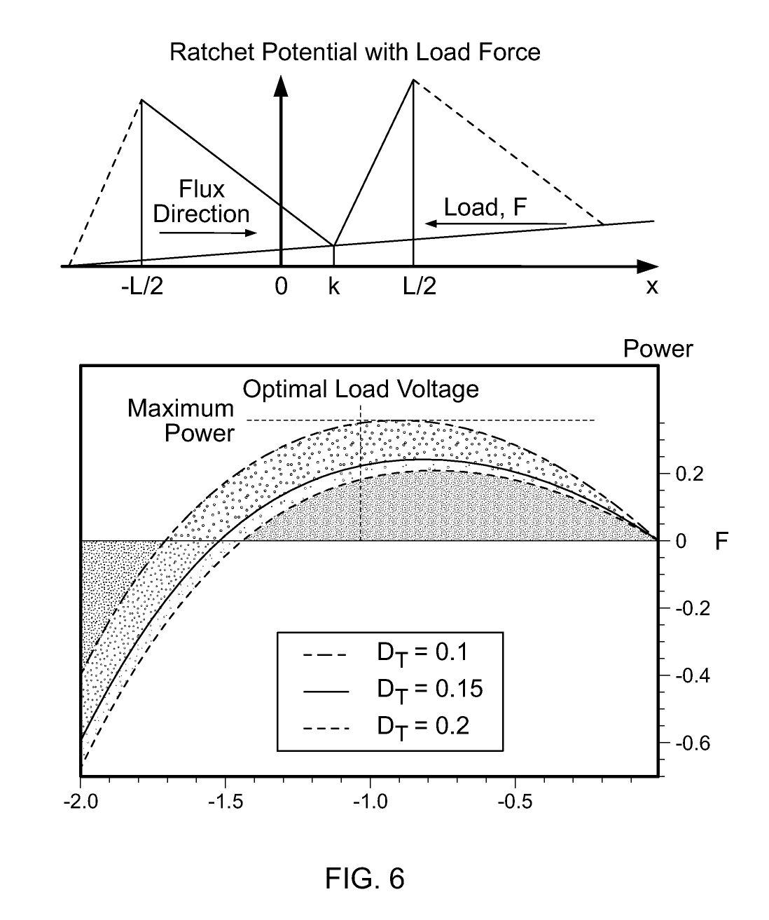

FIG. 6 shows a power generation principle. λ=10, k=0.4975, Dₛ=0.03025.

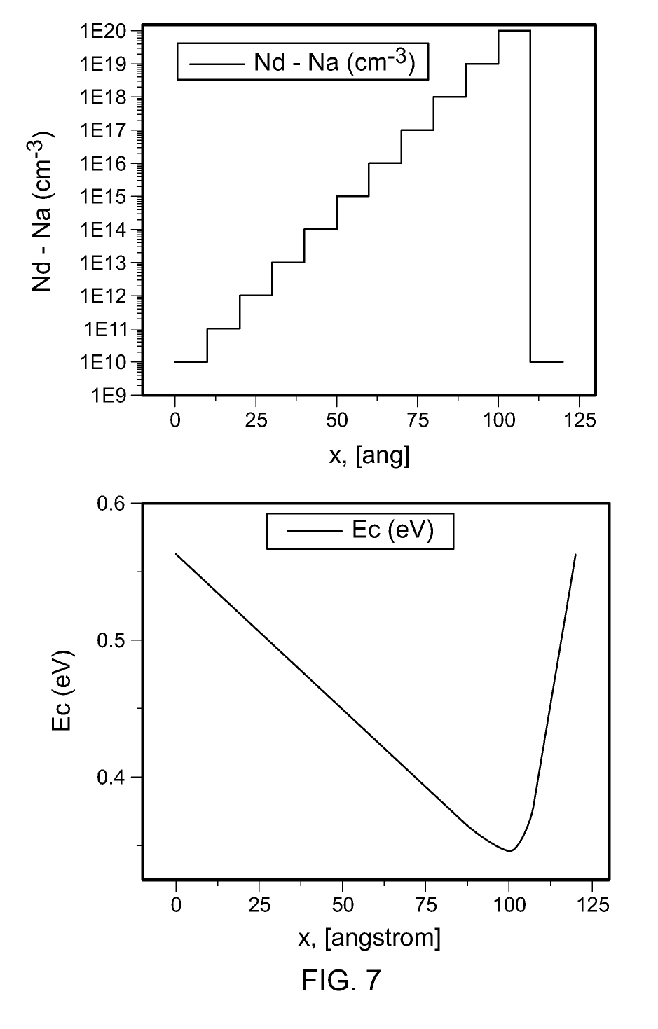

FIG. 7 shows periodic doping of silicon that sets up an asymmetric ratchet potential on a nanometer scale.

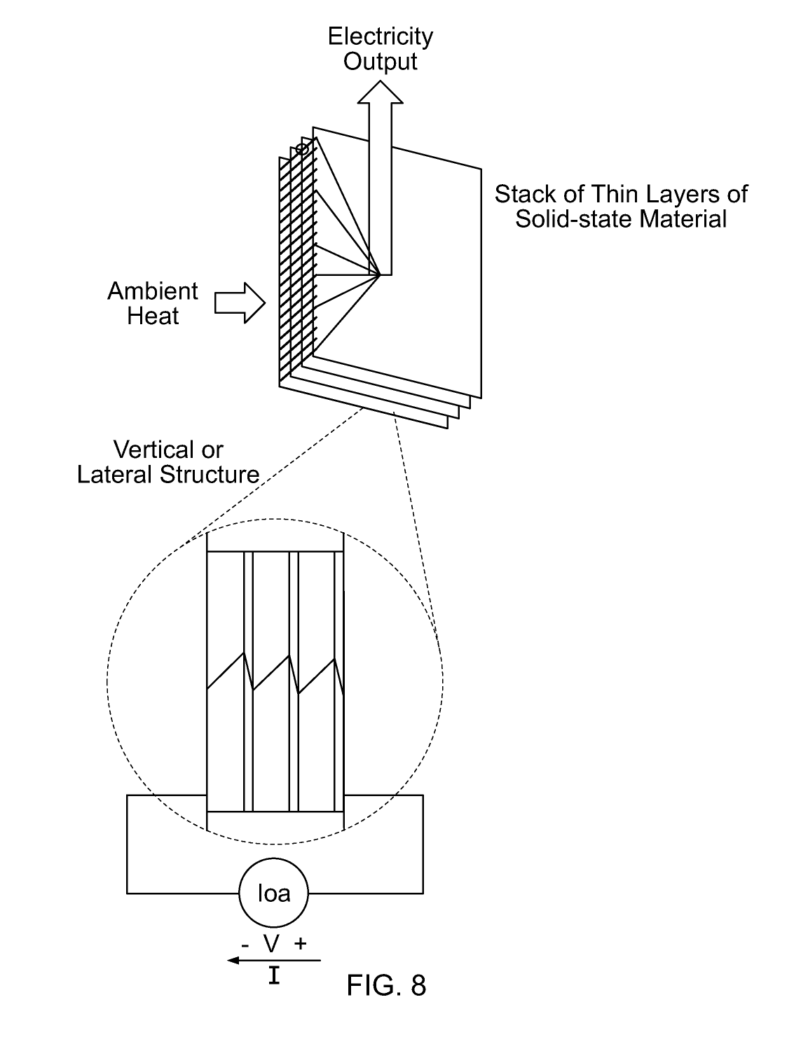

FIG. 8 shows an example extraction module.

A key breakthrough in what we describe here is a new energy conversion/extraction system and technique (we sometimes use the terms conversion and extraction interchangeably) in which an appropriately designed asymmetry in a system's structure permits useful (e.g., electrical) energy to be extracted from random forces. In some examples, the random forces are energy fluctuations of conduction electrons and/or valence holes that are both random and average-zero, spatially and temporally.

When we use the word “renewable” we broadly mean, for example, that the ability to extract energy from the system can be sustained (in some cases continuously) without having to provide fuel to the system, but rather, the system replenishes its internal energy from an influx of heat energy from the ambient environment, which in turn is ultimately provided by the Sun.

We use the term extraction in a broad general sense to include, for example, any generation, conversion, or extraction of energy in any form, for any period, and in any way such that the extracted energy is usable externally (or internally) to the system.

In order to show that ambient heat energy can be used for power generation (we sometimes use the term power roughly and somewhat interchangeably with the term energy and the term generation interchangeably with conversion or extraction), the following two questions will be addressed below: (1) is heat energy extractable in principle?; and (2) how can it be extracted?.

Extractability of Heat Energy

Cyclic energy can be extracted from macroscopic fluctuations. Let us start our description with a very loose analogy. We live in a non-equilibrium environment whose energy is constantly dissipated and replenished by the Sun; such energy flows lead to emergence of macroscopic fluctuations of various thermodynamics parameters such as temperature or pressure leading to, e.g., winds. Clearly such macroscopic fluctuations can be and are successfully used for power generation e.g. by wind turbines. Can similar principles of power generation be applied in the microscopic world? Below we look at this question in greater detail.

Fluctuations are significant in microscopic systems. It has been long known that even in the absence of thermodynamic gradients (i.e., for the purpose of this discussion, in equilibrium state) matter undergoes fluctuations in energy/temperature and other thermodynamic parameters on a microscopic scale (Landau, L. D. & Lifshitz, E. M. Chapter XII, Fluctuations in Statistical Physics, Course of Theoretical Physics (Elsevier, Oxford, UK, 1980)). First, we briefly review the origin of such fluctuations. Let us consider a system consisting of a small subsystem and a large system (environment); the total entropy change of such system due to random heat energy exchange between subsystem and environment at equilibrium can be calculated exactly and is:

$$Δ {S}_{Tot} = - \frac{Δ U - {T}_{env} Δ S + P Δ V}{{T}_{env}} ,$$

where unscripted quantities refer to thermodynamic parameters of the subsystem in standard notation. Since entropy by definition is related to the number of microstates available to the system in a particular state, we can use ΔS_{Tot} to calculate the probability (p) of such a state as:

$$p \sim {e}^{\frac{Δ {S}_{Tot}}{{k}_{B}} .}$$

Thus, p is the probability that a certain parameter of the subsystem (for example, temperature) will spontaneously change by the amount defined in the above expression for the ΔS_{Tot}; nonzero values of p imply that thermodynamic parameters fluctuate even at thermal equilibrium. Using the above expression for p, one can find that energy and temperature fluctuations of the subsystem are given by: [symbol] ΔE² [symbol] =RT²Cᵥ and

$$〈 Δ T 〉 = \frac{{RT}^{2}}{{C}_{v}}$$

where Cᵥ is heat capacity and R=k_{B}/N_{A} is gas constant.

Note that relative fluctuation values (i.e.,

$$\frac{Δ E}{E} or \frac{Δ T}{T} )$$

given by the above formulas are negligible for macroscopic systems. However, for small systems they become very significant. FIG. 1 illustrates how the magnitude and rate of temperature fluctuations depends on size of the system for silicon. For example, a 1 nm spherical body of monocrystalline silicon will undergo temperature fluctuations on the order of 36.7 degrees K. Similarly, it can be shown (see Landau et al.) that entropy fluctuations of a system of a given size are [symbol] ΔS² [symbol] =RC_{P} where C_{P} is heat capacity at constant pressure. This last formula clearly shows that the entropy of microscopic subsystem in contact with an isothermal heat bath can both increase and, more surprisingly, sometimes decrease in the absence of external work sources or thermal gradients. Indeed, such entropy consuming processes by now have been experimentally demonstrated for small systems (Wang, G. M., Sevick, E. M., Mittag, E., Searles, D. J., & Evans, D. J. Experimental demonstration of violations of the second law of thermodynamics for small systems and short time scales. Physical Review Letters 89, (2002); Liphardt, J., Dumont, S., Smith, S. B., Tinoco, I., & Bustamante, C. Equilibrium information from nonequilibrium measurements in an experimental test of Jarzynski's equality. Science 296, 1832-1835 (2002); and Bustamante, C., Liphardt, J., & Ritort, F. The nonequilibrium thermodynamics of small systems. Physics Today 58, 43-48 (2005)).

One cannot extract cyclic energy from a system in thermodynamic limit, exhibiting a Gaussian/white noise. We propose that such fluctuations can be harnessed for energy production. However, can energy be extracted from an isothermal bath? The answer to this seemingly simple question follows directly from thermodynamic laws. Specifically the 2^{nd} law of thermodynamics defines conditions under which useful work can be extracted from the environment. It is typically assumed that one of the requirements for such extraction is existence of a generalized gradient of a thermodynamic parameter (for example, temperature). In the absence of such a gradient or any kind of stored energy, extraction of work from an isothermal bath would constitute a Maxwell-demon type of perpetuum mobile of the second kind.

One example is Feynman's ratchet (Feynman, R., Leighton, R., & Sands, M. Chapter 46 in The Feynman Lectures on Physics (Addison-Wesley, Massachusetts, USA, 1964); Magnasco, M. O. & Stolovitzky, G. Feynman's Ratchet and Pawl. Journal of Statistical Physics 93, 615-632 (1998)). In his lecture, Feynman showed that it is impossible to extract useful energy from a ratchet-and-pawl system if the two reservoirs containing the ratchet and the pawl are at the same temperature. Note, that Feynman's proof is based on the assumption of thermal noise, e.g., Gaussian white noise and consequently Boltzmann statistics.

However, it is important to note that the 2^{nd} law holds rigorously only for closed systems in thermodynamic limit, i.e., in the absence of energy flows and for large systems where fluctuations of thermodynamic parameters become relatively negligible. For example according to Clausius' formulation of the 2^{nd} law “a transformation whose only final result is to transfer heat from a body at a given temperature to a body at a higher temperature is impossible”. In principle, the 2^{nd} law is the only physical law that defines a direction of time based on the concept of statistical reversibility and therefore holds rigorously for systems with enormous number of atoms for which statistical description is extremely accurate. An important key idea for the feasibility of our proposed method is that the 2^{nd} law is not applicable to small and open systems and on short time scales (see Wang et al., Liphardt, et al., and Bustamante, et al.). It is important to realize that the statement that total entropy of the closed system can only stay constant or increase in the absence of external energy/work sources is accurate only on average and applies to average quantities in thermodynamic limit.

Extraction Mechanism

A Brownian ratchet can extract cyclic energy from a nonequilibrium system, even if there's no permanent gradient. In this section, we describe the principle of operation of our proposed technique, system, method, and device to extract cyclic energy/power. It is well established that a macroscopic current can be obtained in periodic asymmetric structures (Brownian ratchets) without application of any external bias force or temperature gradient under non-equilibrium conditions (Reimann, P. Brownian motors: noisy transport far from equilibrium. Physics Reports-Review Section of Physics Letters 361, 57-265 (2002); Astumian, R. D. Thermodynamics and kinetics of a Brownian motor. Science 276, 917-922 (1997); Bader, J. S. et al. DNA transport by a micromachined Brownian ratchet device. Proceedings of the National Academy of Sciences of the United States of America 96, 13165-13169 (1999)). In such ratchet systems particles in spatially periodic potential are transported in a preferential direction by unbiased mean-zero non-equilibrium (random or deterministic) forces. Non-equilibrium is a key condition for operation of a Brownian ratchet.

Visual description of why Feynman's ratchet cannot work if noise is Gaussian/white. It directly follows from the 2^{nd} law of equilibrium thermodynamics, however, that directed stationary motion cannot be generated by random thermal fluctuations in a thermal bath (i.e., with Gaussian white noise) irrespective of the presence of an asymmetric periodic potential. This is so because Gaussian white thermal noise cannot break the detailed balance condition as has been shown by Feynman using the above mentioned ratchet and pawl example (see Feynman et al. and Magnasco et al.).

To illustrate the physics of the dynamics of the ratchet at equilibrium versus non-equilibrium, we turn to the stochastic description of the system. The stochastic dynamics of Markovian process x(t) (where x(t) indicates particle position) can be described by a master equation approach (Hanggi, P. Langevin Description of Markovian Integro-Differential Master-Equations. Zeitschrift fur Physik B-Condensed Matter 36, 271-282 (1980)), \dot{p}(x,t)=∫Γ(x,y,t)p(y,t)dy, where Γ(x,y,t) describes probability of a particle transition from position y to position x (in chemical literature Γ(x,y,t) is called the rate constant) and p refers to the population of the particles. At equilibrium, the population of particles at any given x in the presence of a potential energy surface is given by Boltzmann distribution, p(x)˜e^{-V(x)/k}^{_{B}}^{T} where V(x) is an asymmetric potential energy surface (PES) such as one shown in FIG. 2. At the same time, according to the transition state theory (Hanggi, P., Talkner, P., & Borkovec, M. Reaction-Rate Theory—50 Years After Kramers. Reviews of Modern Physics 62, 251-341 (1990)), the rate constant for particle transition over the barrier is given by: Γ˜e^{-(V}^{ₘₐₓ}^{-V(x))/k}^{_{B}}^{T}. Due to exponential dependence of both p(x) and Γ(x), the product p(x)Γ(x) in the master equation is independent of V(x) indicating that for any shape of the PES, any particle has equal probability to transition (and equally to the right or to the left), and as such, no particle current should be expected (see FIG. 3).

Detailed balance is lost if noise is non-Gaussian/white. However, the conclusions of equilibrium thermodynamics are not generally applicable to non-equilibrium systems. It has been shown theoretically that directed stationary motion can materialize in spatially asymmetric systems with symmetric, correlated, non-white and in general non-Gaussian noise. (Magnasco, M. O. Forced Thermal Ratchets. Physical Review Letters 71, 1477-1481 (1993); Luczka, J., Czernik, T., & Hanggi, P. Symmetric white noise can induce directed current in ratchets. Physical Review e 56, 3968-3975 (1997); Czernik, T. & Luczka, J. Rectified steady flow induced by white shot noise: diffusive and non-diffusive regimes. Annalen der Physik 9, 721-734 (2000); Kim, C., Lee, E. K., Hanggi, P., & Talkner, P. Numerical method for solving stochastic differential equations with Poissonian white shot noise. Physical Review e 76, (2007); Luczka, J., Bartussek, R., & Hanggi, P. White-Noise-Induced Transport in Periodic Structures. Europhysics Letters 31, 431-436 (1995); and Luczka, J. Application of statistical mechanics to stochastic transport. Physica A 274, 200-215 (1999)) In the presence of such noise, the Brownian ratchet works somewhat like a mechanical diode capable of rectifying to some extent any input except white thermal noise. If the particle in the asymmetric PES is subject to an external random force having time correlations (colored noise), detailed balance is lost and particle current results (see Magnasco). Note that most environments at equilibrium exhibit Gaussian thermal noise because of the central limit theorem. However, if the system is not at equilibrium (e.g., is in a nonequilibrium steady state), it will exhibit noise that deviates from the Gaussian statistics (e.g., Poisson noise in a system that is not in thermodynamic limit) and/or will contain time-correlations (e.g., memory effect in the material).

Stochastic Modeling

Gaussian noise is the limiting case of Poisson-noise-governed events. Of particular importance for our technology is the Poissonian noise process. (see Hanggi et al.) It is intrinsically non-Gaussian, and thus is expected to lead to non-equilibrium ratchet dynamics that do not satisfy the fluctuation-dissipation relation. Solid state and molecular systems can be described by Poisson rather than Gaussian statistics whenever interactions between the particles and the environment are infrequent or unusually strong or both. Since Gaussian noise is a limiting case of Poisson noise when the number of events goes to infinity, the Poisson noise emerges automatically in most systems when the system size decreases to the nanometer scale. Hence it is of interest to consider what effect such noise would have on Brownian ratchet dynamics. In our discussion, we use the term event broadly to refer, for example, to the scattering of a conduction electron from a lattice.

Poisson noise and an appropriate asymmetry can generate net flux. Below we show how the symmetric Poissonian noise can induce macroscopic current in an asymmetric periodic potential shown in FIG. 2. We use the Langevin equation approach, which enables coarse-grained incorporation of the stochastic interactions between the particles and the environment in the most intuitive way:

$$m \ddot{x} ( t ) = - \frac{d V ( x , t )}{d x} - γ \dot{x} ( t ) + {ξ}_{T} ( t ) + {ξ}_{P} ( t ) ,$$

where γ is the friction coefficient and ξ_{T}(t)+ξ^{P}(t) is the source of noise. When ξ_{T}(t) is Gaussian white noise, the friction coefficient can be related to ξ_{T}(t) through the fluctuation-dissipation theorem: [symbol] ξ_{T}(t)ξ_{T}(t′) [symbol] =2γ_{T}k_{B}Tδ(t−t′) and to the transport (diffusion) coefficient through the Einstein-Smoluchowski relation:

$${D}_{T} = \frac{{k}_{B} T}{{γ}_{T}} .$$

We have assumed that ξ_{P}(t) is the Poissonian white noise process defined as: ξ_{P}(t)=Σᵢzᵢδ(t−tᵢ), with noise amplitudes zᵢ distributed according to the symmetric exponential probability density:

$$ρ ( z ) = \frac{1}{2 A} {e}^{- \vert z \vert / A} ;$$

note [symbol] ξ_{P}(t)ξ_{P}(t′) [symbol] =2λA²δ(t−t′).

Thus, the Poissonian process consists of δ-function shaped pulses with the number of the events (k) per unit time given by

$$P ( k ) = \frac{{( λ t )}^{k} {e}^{- λ t}}{k !}$$

and the strength of these pulses distributed according to ρ(z). The parameter A is the average amplitude of these Poisson “kicks”. Note that Poisson white noise approaches Gaussian white noise in the limit of λ→∞, A→0 while Ds=λA² is kept constant, i.e., in the limit of a very large number of low magnitude pulses. Further we have considered overdamped Brownian particles for which the inertial term m\ddot{x}(t) can be ignored; this is a commonly used assumption valid for microscopic dynamics on macroscopic time scales (e.g. microseconds to seconds) that are long compared to the energy/momentum dissipation time scale (e.g. femtoseconds to picoseconds).

The resulting stochastic differential equation was solved numerically using standard methods of stochastic calculus. FIG. 4 (left panels) shows the resulting particle population distribution functions for the case of Poissonian and Gaussian white noise. Note the difference between the shape of distribution function inside each periodic PES “well”; in the case of Gaussian white noise the population distribution is roughly exponential indicating that particles are distributed according to Boltzmann distribution as expected at equilibrium while in the case of Poisson white noise the distribution is clearly non-exponential. Therefore, since p(x) is not exponential, the detailed balance condition should be broken (see above discussion using master equation). Indeed, FIG. 4 (right panels) shows that the average position of the particle is increasing for the Poisson case (top panel), while in the Gaussian case, the particle position fluctuates around the initial position; this result unequivocally proves that in the case of Poissonian white noise, there is a macroscopic particle flux from the left to the right in this example (i.e., starting at the minima of PES, and going towards the short segment of the period, towards the right). Assuming that the particles are charged (e.g., electrons) such macroscopic flux implies charge current, and thus, can be exploited for energy extraction.

Need to break down detailed balance to generate net flux from fluctuations. As we indicated above, the condition that p(x) is not a Boltzmann distribution is sufficient for detailed balance to be broken. In addition, the detailed balance can also be broken if barrier transition rates Γ(x) are not exponentially dependent on the potential energy barrier height.

Analytical Master Equation Approach

Poisson noise leads to non-locality and correlation of events. Further insight can be obtained by considering the master equation for the probability distribution P(x,t) of a particle under the influence of both thermal and Poisson noise (Vankampen, N. G. Processes with Delta-Correlated Cumulants. Physica A 102, 489-495 (1980)):

$$\frac{\partial P ( x , t )}{\partial t} = - \frac{\partial }{\partial x} f ( x ) P ( x , t ) + {D}_{T} \frac{{\partial }^{2}}{{\partial }^{2} x} P ( x , t ) + λ {\int }_{- ∞}^{∞} ( P ( x - z , t ) - P ( x , t ) ) ρ ( z ) d z , \qquad ( 1 )$$

where

$$f ( x ) = - \frac{d V ( x , t )}{d x} .$$

This equation is the usual form of diffusion equation with the drift term except for the presence of the last term that is specific for the Poisson noise. Note that the Poisson term is non-local, indicating that the probability change, at any specific point x, is influenced by the presence of particles at locations remote to x, i.e., within a correlation sphere defined by the width of the amplitude distribution of the Poisson noise.

If the correlation sphere becomes small (delta function), the Poisson term turns into a regular diffusive term with diffusion coefficient Dₛ. Such non-locality is a distinctive feature of Poisson noise, enabling a non-zero current in the presence of an asymmetric potential energy profile in the system. Eq. 1 can be solved analytically for piecewise linear potential as shown in FIG. 2, which enables calculation of the dependence of flux on system parameters, such as the frequency of events (X), the asymmetry parameter (k), or unitless diffusion coefficients for thermal/Gaussian and (in this example) non-thermal/Poisson noise (D_{T} or Dₛ, respectively). In FIG. 5 (top panel), we show the flux dependence on the thermal diffusion coefficient (D_{T}) at different values of Dₛ and at a constant value of λ (i.e., at different values of A, the Poisson kick amplitude, which is typically in single digit nm's for the system size scale considered here). Also note that the dependence on D_{T} in our model is equivalent to the dependence on temperature. Inspection of the graph immediately reveals that there are two regimes of operation.

Ratchet regime: Poisson kicks perturb equilibrium. When parameter A is small compared to δ (green curve in FIG. 5, top panel), Poisson kicks are too short to overcome the potential energy barrier; therefore flux of particles is small; however, when the temperature (˜D_{T}) increases, the flux increases dramatically. This is a true Brownian ratchet regime. Poisson kicks act by perturbing the equilibrium distribution while thermal noise drives the current, reminiscent of the operation of flashing Brownian ratchets (see Reimann). At still higher temperatures, the flux decreases, because the thermal noise becomes dominant and washes out any net flux due to the asymmetry.

Delta regime: Poisson kicks generate the flux. At large values of A (e.g., A≧δ), the Poisson kicks are stronger, reaching beyond the nearest potential energy maximum. As soon as particles (conduction electrons) are kicked over the barrier, they continue sliding towards the next PES minimum, creating a strong flux. In this case, the higher temperature is detrimental to the magnitude of the current because thermal noise slows down the sliding-down process. Therefore, the maximum current appears at lower temperatures (the line in FIG. 5, top panel, that is highest on the left and in the middle on the right). The maximum in flux (as a function of D_{T}) disappears completely at even larger values of A (i.e. of D_{S}) than used in the calculations used for FIG. 5.

Transition to an operation regime that is not accessible to Nature, but only to solid state systems. A phase diagram shown in FIG. 5 (lower panel) displays a phase boundary between the two operation regimes that indicates that the regime of operation of a Poisson ratchet is governed by (and is exponentially sensitive to) the asymmetry of the potential (k) and the magnitude of Poisson kicks (A). And considering the flux values, it is more advantageous to design the system towards both higher k (as close to 0.5 as possible, for example) and higher A (further into the Delta regime).

Power Generation

Introducing a load for power extraction. In order to demonstrate that the current induced in Poisson ratchet could be used for power generation, we have modified the ratchet potential by including a load force component as shown in FIG. 6 (top panel). FIG. 6 (lower panel) displays the generated power as function of applied load (similar to a car battery, for which the output voltage is ˜14V without a load, and is lowered to 12V during discharge). The figure clearly shows that the Poisson ratchet is able to drive a current against a loading force, thereby performing useful work. The output power exhibits a peak at an intermediate value of loading force, followed by a decrease to negative values when the loading force becomes so strong that it reverses the current direction (and net power is no longer extracted).

Summary of Extraction Mechanism

Non-Gaussian/white noise leads to non-locality and force-dependent dynamics. When the system size becomes sufficiently small, the description of the thermal noise has to include a Poisson noise component because the number of events (e.g., interactions between electrons and the lattice) becomes infrequent. As we have described above, the Poisson noise (non-Gaussian) leads to emergence of a directional current in the asymmetric system. The Poisson noise acts as a source of local non-equilibrium perturbation, which in turn allows current rectification by the asymmetric system.

Alternative interpretations are possible to elucidate the appearance of a directional flux. Existence of a non-local term in the master equation due to Poisson noise (1) delocalizes the effect of the PES on the particle dynamics, and/or (2) the rate of change in population of the particles at a particular spatial point is no longer determined by only the population and its gradients at that particular point but also is determined by remote populations within the Poisson kick distance (A). The immediate consequence of such non-locality is that the dynamics are controlled not only by the maximum energy point of the PES but also by the specific shape of the PES, e.g., by the forces acting on a particle due to the PES. In other words, force-dependent dynamics arise in the system (rather than strictly energy-dependent dynamics). Such sensitivity to the PES shape is why the asymmetry of the PES becomes a relevant factor to the Poisson ratchet dynamics and enables noise rectification; that is, a spatially asymmetric PES provides different regions with different forces acting on particular electrons, even if those electrons have the same potential energy.

1^{st} and 2^{nd} laws of thermodynamics as applied to Poisson ratchets. The non-Gaussian and/or non-white noise component (e.g., the Poisson noise) acts as a source of local non-equilibrium perturbation to the system. Furthermore, the proposed system is an open system that can freely exchange heat energy with the environment and exchange charge carriers with the load. Finally, the overall ambient heat energy of the environment (e.g., of the Earth) is replenished by the Sun. As such, the conversion of heat energy fluctuations into useful work in our proposed method and device and the corresponding decrease in entropy of the system is compensated by the entropy influx into the system from the environment, and neither the 1^{st} nor the 2^{nd} law are violated by this extraction.

System Implementation

A Proof-of-Concept Design

As mentioned above, there are many ways to achieve a system that exhibits non-Gaussian and/or non-white noise, as well as many ways to implement an appropriate asymmetry into the system. In the example we provided above, the noise term has a Poisson component due to the small size of the system (e.g., the system is no longer in the thermodynamic limit). And, for the asymmetry, in the example we have discussed, a solid state system has an appropriately designed structure implementing a periodic potential energy profile. In some implementations, a periodic structure is imposed by periodic multistep gradient doping of silicon with n-type or p-type dopant. The goal is to achieve a periodic structure on nanometer scale with a high (e.g., the highest possible) asymmetry and a good (e.g., optimum) PES modulation depth.

We have performed simulations of one such multistep doping profile in silicon (FIG. 7, top panel) to test if an adequate PES profile could be obtained. FIG. 7 (lower panel) shows the resulting conductance band energy profile which is clearly asymmetric and has an adequate modulation amplitude of >0.2 V (e.g., >8 kT at room temperature); this profile was obtained by solving the one-dimensional Poisson and Schrödinger equations self-consistently.

Performance Estimates

In the example we are discussing, we assumed 40×4″ Silicon wafers (each wafer ˜0.5 mm thick), stacked on top of each other with a 2 mm gap in between each adjacent pair of wafers, giving approximately a 10 cm-on-an-edge cube. Then, using Poisson ratchet simulations based on the master equation approach and considering the specific solid state parameters (and assuming another 2:1 fill factor to allow spacing between the ratchet periods in a wafer), such a cube is expected to deliver ˜580 W of electricity, which translates to a power density of approximately 0.6 kW/L or 1.2 kW/kg, at a capital cost of $2/W (assuming a 45% and a 55% wafer cost and processing cost, respectively). In this calculation, we assumed that the ratchet potential (PES depth) is 0.26 V (10 kT), the period length=340 nm and δ=1 nm, resulting in current density of 21.3 A/m² and optimal load voltage of 93 mV per one ratchet period (i.e., per L). Stacking of the wafers increases the overall surface area for heat exchange to occur (which is required to replenish the extracted power); the average heat flux density for this cube is approximately 1.5 kW/m², well below manageable limits. For carbon-based materials, e.g. graphite or grapheme, the period length (L) would typically be in the 5-25 μm (due to higher electron mobility in these materials), leading to different performance and cost numbers.

Fabrication and Improvements

Some implementations could be done using only low-cost materials and manufacturing processes (e.g., silicon, graphite, and aluminum), fabricated with current planar processes. Depending on the PES period, both vertical and/or lateral structures are possible. The design is expected to be improved by using more optimized and sophisticated PES profiles or by incorporating various biasing schemes or both.

The above discussion has been restricted to generation of a net flux strictly arising from classical currents; however, at the nanometer scale, quantum tunneling currents and non-local electronic wavefunctions are routine, and offer additional opportunities for better performance at lower cost.

A wide range of other implementations are also within the scope of the claims.

1. A method comprising extracting renewable energy from an asymmetric system that is characterized by one or more stochastic variables, which exhibit at least one statistical component that is not Gaussian or not white or both.

2. A method comprising enhancing an ability of a system to have renewable energy extracted from it, the system comprising an asymmetric system that is characterized by one or more stochastic variables, which exhibit at least one statistical component that is not Gaussian or not white or both.

3. The method of claim 1 in which the renewable energy is extracted in the form of power.

4. The method of claim 1 in which the energy comprises electrical, thermal, chemical, or radiative energy or a combination of them.

5. The method of claim 1 in which at least part of the system is in a solid phase, a liquid phase, a gas phase, or an intermediate phase or a combination of them.

6. The method of claim 1 in which at least part of the system is in a solid phase comprising a semiconductor, an amorphous material, an organic material, or a plasma, or a combination of them.

7. The method of claim 1 in which the energy is extracted from conduction electrons, valence holes, or phonons present in the asymmetric system, or a combination of them.

8. The method of claim 1 in which the asymmetric system comprises an asymmetry of a fixed structure in the system, of an intrinsic aspect of the system, of an externally fabricated feature of the system, or is imposed on the system by an externally applied force, or a combination of them.

9. The method of claim 1 in which the asymmetric system comprises an asymmetry that is spatial or temporal or a combination of them.

10. The method of claim 1 in which the asymmetric system comprises an asymmetry that is deterministic or stochastic or a combination of them.

11. The method of claim 1 in which one or more of the stochastic variables comprise thermodynamic or other microscopic variables or a combination of them.

12. The method of claim 1 in which the stochastic variables comprise temperature, entropy, enthalpy, or kinetic energy of charge carriers, or a combination of them, such as translational, rotational, or vibrational energy or a combination of them.

13. The method of claim 1 in which at least one of the stochastic variables is spatial or temporal or a combination of them.

14. The method of claim 1 in which at least one of the stochastic variable is an amplitude or a temporal or spatial pattern or a combination of them.

15. The method of claim 1 in which the statistical component has a mean value of zero.

16. The method of claim 1 in which the statistical component has a mean value that is non-zero.

17. The method of claim 1 in which the statistical component is intrinsic to the system or designed into the structure of the system or externally applied to the system or a combination of them.

18. The method of claim 1 in which non-localization or correlation effects in the system or a combination of them are increased or optimized.

19. The method of claim 18 in which the increase or optimization is spatial or temporal or a combination of them.

20. The method of claim 1 comprising improving or optimizing the extraction of energy.

21. The method of claim 20 in which the extraction of energy is improved or optimized in net output power, heat management, stability, reliability, manufacturability, or cost, or a combination of them.

22. The method of claim 20 in which the improvement or optimization includes causing a frequency of events, a thermal diffusion coefficient, a non-thermal diffusion coefficient, a kick amplitude, a barrier height, a load voltage, or a load current, or a combination of them to fall within a particular range or ranges of values.

23. The method of claim 20 in which the improvement or optimization comprises applying one or more biases to one or more system parameters.

24. The method of claim 1 in which the energy is extracted in the Ratchet regime or in the Delta regime or in a transition regime between the two regimes, or in a combination of them.

25. The method of claim 1 in which the energy is extracted using quantum effects.

26. The method of claim 25 in which the quantum effects comprise tunneling currents, non-localized electron wavefunctions, or interference effects, or a combination of them.

27. An apparatus, comprising
an asymmetric system from which renewable energy can be extracted, the asymmetric system comprising a fabricated structure that is characterized by an asymmetry and causes at least one statistical component exhibited by one or more stochastic variables to be not Gaussian or not white or both,
the energy extractable from the structure being
greater than the energy that all control and ancillary elements required for the extraction consume.

28. The apparatus of claim 27 in which the fabricated structure comprises a semiconductor material.

29. The apparatus of claim 28 in which the semiconductor material comprises silicon, graphite, or graphene, or a combination of them.

30. The apparatus of claim 27 in which the asymmetry comprises a lateral or vertical structure.

31. The apparatus of claim 27 in which the asymmetry comprises two or more different layers, two or more different materials or two or more different doping levels, or a combination of them, in the structure.

32. The apparatus of claim 27 in which the stochastic variables comprise thermal fluctuations.

33. The apparatus of claim 32 in which the thermal fluctuations are of conduction electrons or valence holes or a combination of them.

34. The apparatus of claim 27 in which the statistical component has a Poisson distribution.

35. A fabricated structure from which renewable energy can be extracted, comprising an asymmetry and characterized by at least one statistical component exhibited by one or more stochastic variables being not Gaussian or not white or both.

36. The structure of claim 35 comprising a stack of wafers.

37. A method comprising fabricating a structure from which renewable energy can be extracted, the fabricating comprising imparting to the structure an asymmetry and causing at least one statistical component exhibited by one or more stochastic variables associated with the structure to be not Gaussian or not white or both.

38. The method of claim 1 comprising heat energy flowing in from the ambient environment to permit continuous extraction of energy.

39. The method of claim 1 comprising extracting the energy in the presence of a load.

40. The method of claim 1 comprising using the power externally to the asymmetric system.
